(19) United States
(12) Patent Application Publication
(10) Pub. No.: US 2024/0273155 A1
(43) Pub. Date: Aug. 15, 2024

(54) PHOTO LOCATION DESTINATIONS SYSTEMS, METHODS, AND COMPUTER READABLE MEDIA

(71) Applicant: Brooke Chehebar, Lakeland, FL (US)

(72) Inventor: Brooke Chehebar, Lakeland, FL (US)

(21) Appl. No.: 18/108,579

(22) Filed: Feb. 10, 2023

Related U.S. Application Data
(60) Provisional application No. 63/287,987, filed on Dec. 10, 2021.

(51) Int. Cl. G06F 16/9537; G06F 16/9032; G06F 16/9538; H04L 9/40

(52) U.S. Cl. CPC G06F 16/9537; G06F 16/90328; G06F 16/9538; H04L 63/083

(57) ABSTRACT

Computer-implemented photo location destinations methods, systems, and computer-readable media are described.

### RELATED APPLICATIONS

This application claims the benefit of U.S. Application No. 63/287,987, entitled “Photo Location Destinations Systems, Methods, and Computer Readable Media,” filed on Dec. 10, 2021, which is incorporated herein by reference in its entirety.

### FIELD

Some implementations are generally related to location-based mobile applications, and, in particular, to photo location destinations systems, methods, and computer readable media.

### BACKGROUND

Users of mobile devices equipped with cameras may wish to capture photos in front of iconic backgrounds in places that they are visiting or plan to visit. A need may exist for a photo location destinations mobile application to provide users with specific guidance on photo location destinations by geographic location, by photo location type, and provide user generated content associated with photo location destinations such as photos or videos including the location destination, reviews of photo location destinations, and other content such as directions, tips for best photos at a given photo location destination, etc.

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

### BRIEF DESCRIPTION OF THE DRAWINGS

FIG. 1 is a block diagram of an example system and a network environment which may be used for one or more implementations described herein.

FIG. 2 is a diagram of an example user interface for a photo location destination mobile application in accordance with some implementations.

FIG. 3 is a diagram of an example user interface for a photo location destination mobile application in accordance with some implementations.

FIG. 4 is a flowchart of an example method for searching a photo location destination database via a mobile application in accordance with some implementations.

FIG. 5 is a flowchart of an example method for uploading user generated content via a photo location destination mobile application in accordance with some implementations.

FIG. 6 is a flowchart of an example method for building a trip itinerary via a photo location destination mobile application in accordance with some implementations.

FIG. 7 is a block diagram of an example computing device which may be used for one or more implementations described herein.

FIGS. 8-17 are diagrams of example graphical user interfaces for a photo location destination mobile application in accordance with some implementations.

### DETAILED DESCRIPTION

Some implementations include photo location destination methods and systems. While photos are mentioned herein as an example, it will be appreciated that photo or photos, as used herein, can include one or more photos, videos, short form videos (e.g., TikToks or Youtube Shorts or the like), reels, other types of media, user generated content, or the like.

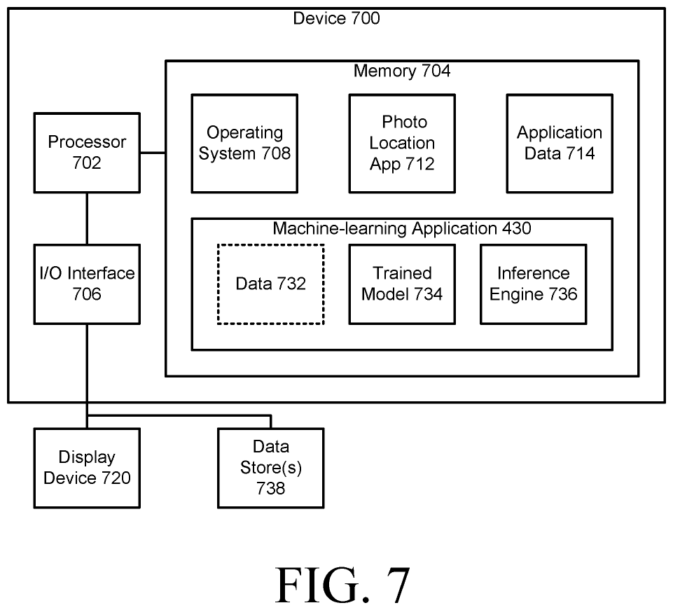

When performing photo location destination functions, it may be helpful for a system to suggest photo location destinations and/or to make predictions about the types or specific ones of photo location destinations that a given user may like. To make predictions or suggestions, a probabilistic model (or other model as described below in conjunction with FIG. 7) can be used to make an inference (or prediction) about aspects of photo location destinations such as the types of photo location destinations a given user may like. Accordingly, it may be helpful to make an inference regarding a probability that a given photo location destination will be liked by a given user. Other aspects can be predicted or suggested as described below.

The inference based on the probabilistic model can include predicting whether a given photo location destination or type of photo location destination will be liked by a user in accordance with image (or other data) analysis and confidence score as inferred from the probabilistic model. The probabilistic model can be trained with data including previous photo location destination data from a given user or group of users. Some implementations can include generating photo location destination predications based on a given user's past photo location destination data and/or data from other users regarding photo location destinations.

The systems and methods provided herein may overcome one or more deficiencies of some conventional photo systems and methods. For example, the disclosed systems and methods may provide data specific to photo location destinations such as locations, reviews, and directions specific to the photo location destination and not to a location generally on a map. Further, photo location destinations may not be typical destinations such as a business, park, or other type of conventional location, but rather may be a destination that is independent of such typical destinations. For example, a photo location destination may be a mural painted on the wall of one or more buildings in an alley. While such a photo location destination may be somewhat known to others based on its visual characteristics and appearance, it may otherwise be difficult to locate on a map and there may be little information collected in a one central place regarding such photo location destinations.

The example systems and methods described herein may overcome one or more of the deficiencies of conventional photo systems to provide users with automated photo location destination suggestions based on one or more factors such as current location, planned location, searches, etc. A technical problem of some conventional photo or map systems may be that such systems do not suggest photo location destinations specifically and/or predict which photo location destinations a given user may enjoy.

Particular implementations may realize one or more of the following advantages. An advantage of a photo location destinations mobile application based on methods and systems described herein is that the suggestions are based on photo location destination data and confidence. Yet another advantage is that the methods and systems described herein can dynamically learn new thresholds (e.g., for confidence scores, etc.) and provide suggestions for photo location destinations that match the new thresholds. The systems and methods presented herein automatically provide photo location destination suggestions that are more likely to be accepted by users and that likely are more accurate.

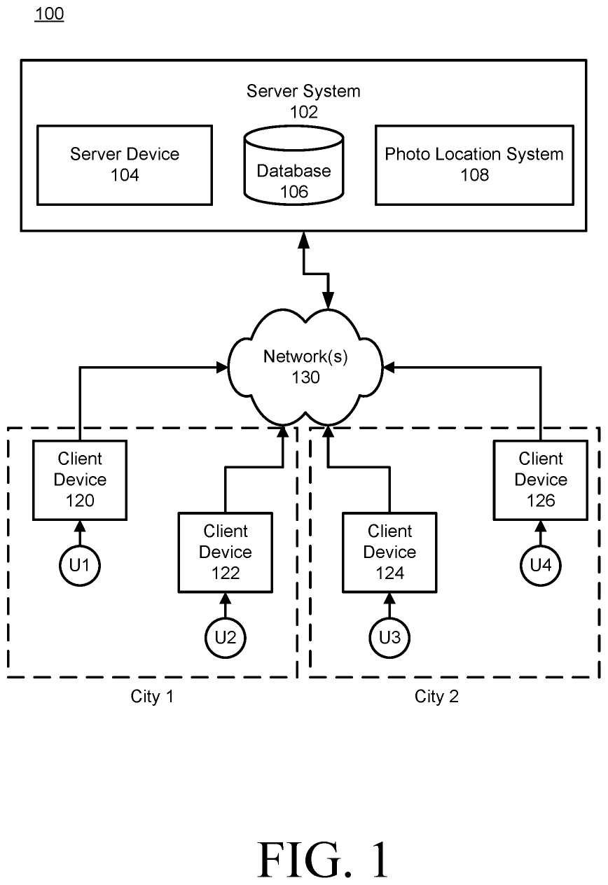

FIG. 1 illustrates a block diagram of an example network environment 100, which may be used in some implementations described herein. In some implementations, network environment 100 includes one or more server systems, e.g., server system 102 in the example of FIG. 1. Server system 102 can communicate with a network 130, for example. Server system 102 can include a server device 104, a database 106 or other data store or data storage device, and a photo location destinations system 108. Network environment 100 also can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication 132 between devices, e.g., using peer-to-peer wireless protocols.

For ease of illustration, FIG. 1 shows one block for server system 102, server device 104, and database 106, and shows four blocks for client devices 120, 122, 124, and 126. Some blocks (e.g., 102, 104, and 106) may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client device can be any type of electronic device, e.g., desktop computer, laptop computer, portable or mobile device, camera, cell phone, smart phone, tablet computer, television, TV set top box or entertainment device, wearable devices (e.g., display glasses or goggles, head-mounted display (HMD), wristwatch, headset, armband, jewelry, etc.), virtual reality (VR) and/or augmented reality (AR) enabled devices, personal digital assistant (PDA), media player, game device, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective client devices 120, 122, 124, and 126. In some examples, users U1, U2, U3, and U4 may interact with each other via applications running on respective client devices and/or server system 102, and/or via a network service, e.g., an image sharing service, a messaging service, a social network service or other type of network service, implemented on server system 102. For example, respective client devices 120, 122, 124, and 126 may communicate data to and from one or more server systems (e.g., server system 102). In some implementations, the server system 102 may provide appropriate data to the client devices such that each client device can receive communicated content or shared content uploaded to the server system 102 and/or network service. In some examples, the users can interact via audio or video conferencing, audio, video, or text chat, or other communication modes or applications. In some examples, the network service can include any system allowing users to perform a variety of communications, form links and associations, upload and post shared content such as images, image compositions (e.g., albums that include one or more images, image collages, videos, etc.), audio data, and other types of content, receive various forms of data, and/or perform socially-related functions. For example, the network service can allow a user to send messages to particular or multiple other users, form social links in the form of associations to other users within the network service, group other users in user lists, friends lists, or other user groups, post or send content including text, images, image compositions, audio sequences or recordings, or other types of content for access by designated sets of users of the network service, participate in live video, audio, and/or text videoconferences or chat with other users of the service, etc. In some implementations, a “user” can include one or more programs or virtual entities, as well as persons that interface with the system or network.

A user interface can enable display of images, image compositions, data, and other content as well as communications, privacy settings, notifications, and other data on client devices 120, 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, e.g., a display screen, projector, etc. In some implementations, application programs running on a server system can communicate with a client device to receive user input at the client device and to output data such as visual data, audio data, etc. at the client device.

In some implementations, server system 102 and/or one or more client devices 120-126 can provide photo location destination functions as described herein.

Various implementations of features described herein can use any type of system and/or service. Any type of electronic device can make use of features described herein. Some implementations can provide one or more features described herein on client or server devices disconnected from or intermittently connected to computer networks.

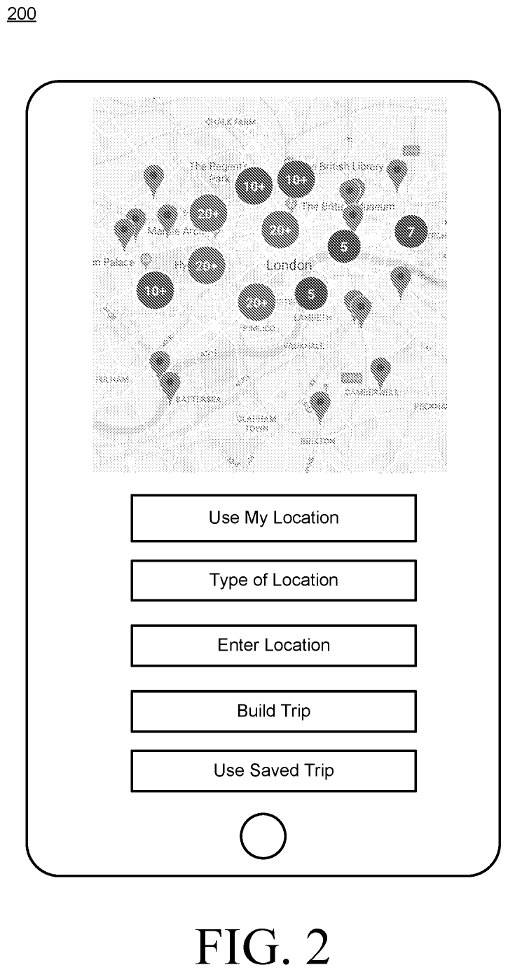

FIG. 2 is a diagram of an example graphical user interface 200 for a photo location destination mobile application in accordance with some implementations. The interface 200 permits a user to select a photo location destination using a current location of the user's device, a type of location, an entered location, and build a trip (or an itinerary) or use a saved trip.

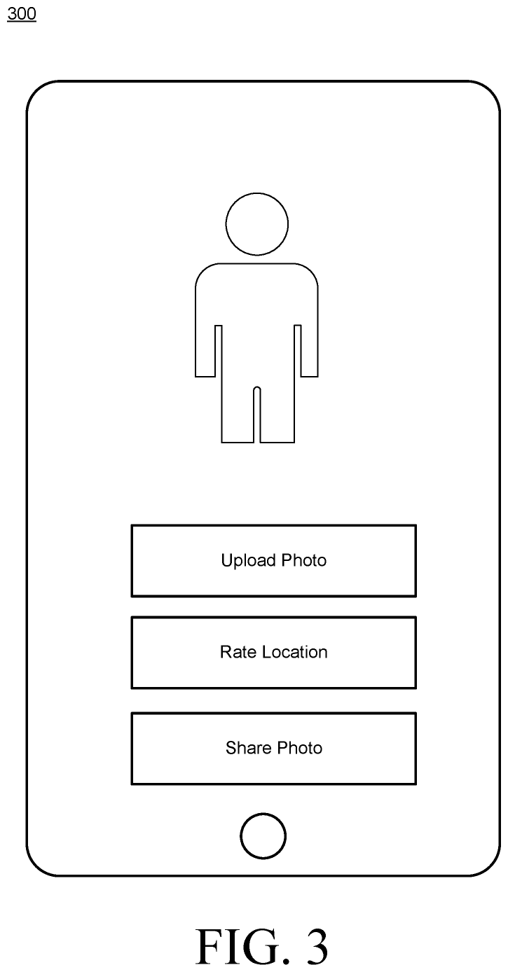

FIG. 3 is a diagram of an example graphical user interface 300 for a photo location destination mobile application in accordance with some implementations. The interface 300 permits a user to provide user generated content by uploading a photo, video, or other media associated with a given photo location destination, rate a photo location destination, and also share a photo, video, or other media associated with a given photo location destination.

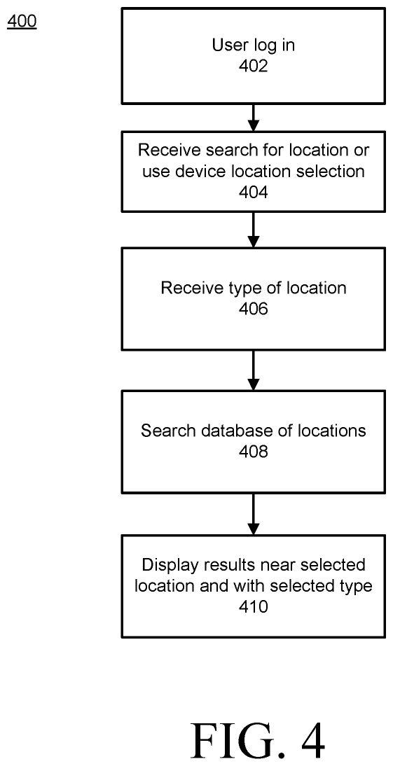

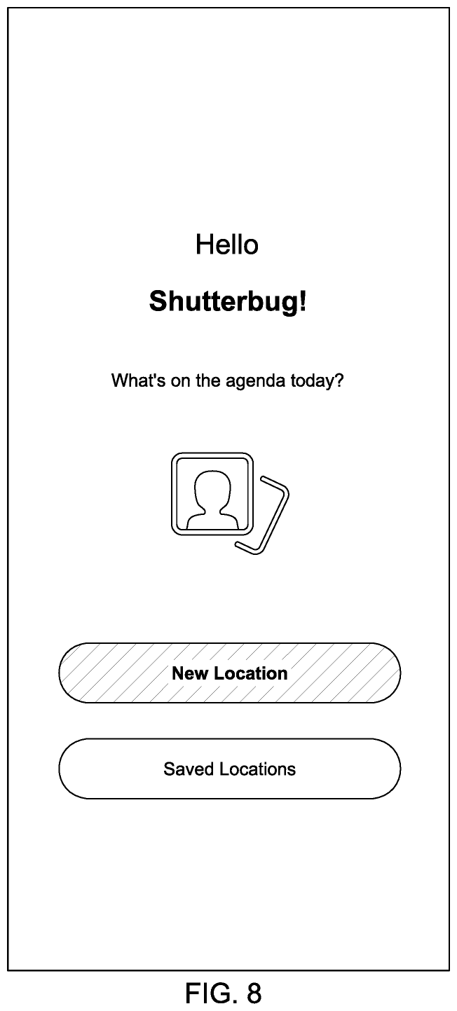

FIG. 4 is a flowchart of an example method 400 for searching a photo location destination database via a mobile application in accordance with some implementations. Processing begins at 402, where a log in is received from a user logging into a photo location destination application. In some implementations, the user may stay logged in through the mobile application such that when the mobile application is opened or selected by the user, the first screen displayed can include a screen with a selection for a new location or a saved location as shown in FIG. 8. Processing continues to 404.

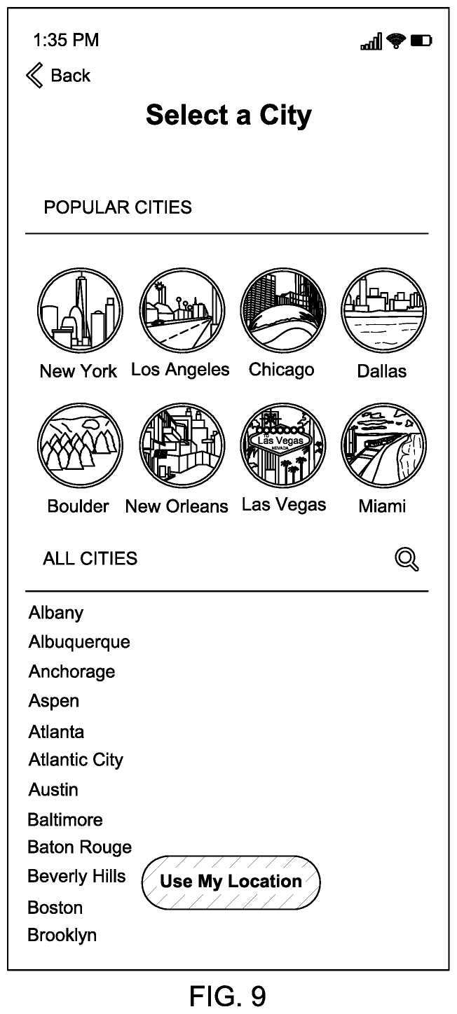

At 404, a search for a photo location destination is received based on a user entered search phrase or a location of the user's device. For example, as shown in FIG. 9, a user interface screen can be displayed in the mobile application that includes selections for a user such as popular cities, all cities, a search element, and a “Use My Location” element. Processing continues to 406.

At 406, an indication of a type of location is received (e.g., a selection from the user interface shown in FIG. 9). Processing continues to 408.

At 408, a database of photo location destinations is queried using one or more of the items of information received in steps 404 and 406. Processing continues to 410.

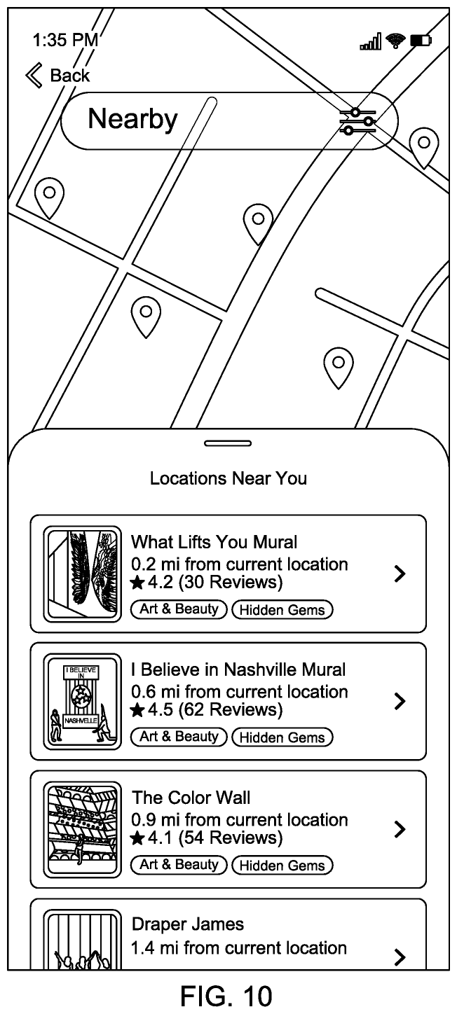

At 410, display results of database query (e.g., display photo location destinations near user location, an example of which is shown in FIG. 10 and matching selected type). In addition to the results of the database query or as a way to order results of the query, outputs of a machine learning model as discussed below can be used to provide suggestions to the user or to rank database query results.

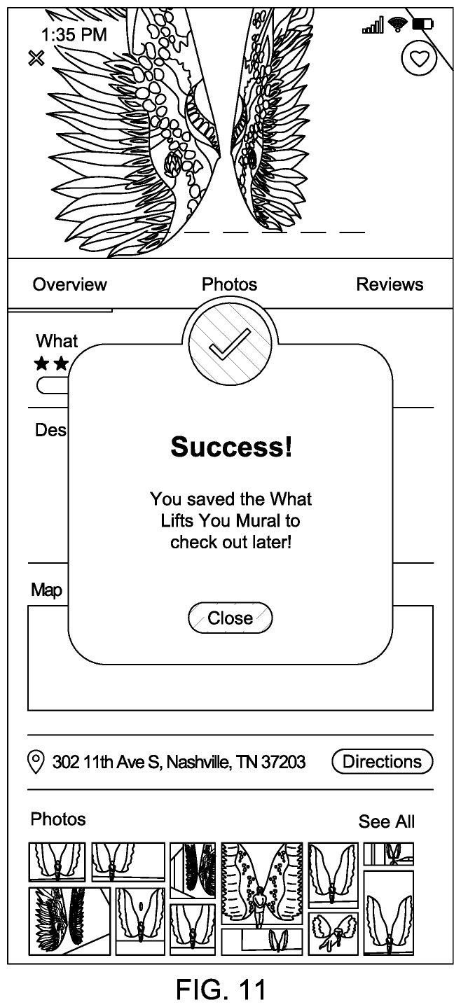

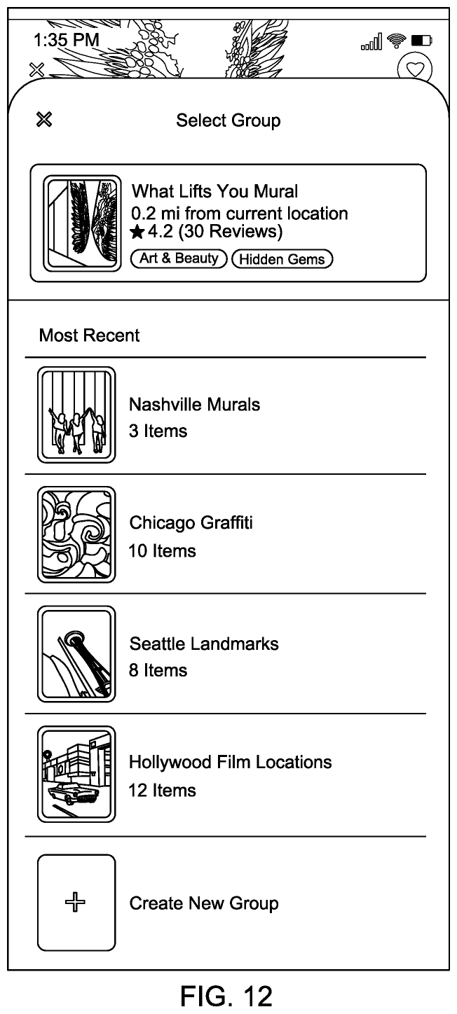

As shown in FIG. 11, a location result can be saved by the user to a list of locations to view later or as part of a saved itinerary. FIG. 12 shows an example of saved location lists or itineraries in which a location can be saved. Also shown in FIG. 12, a new group can be created and the location saved to the newly created group.

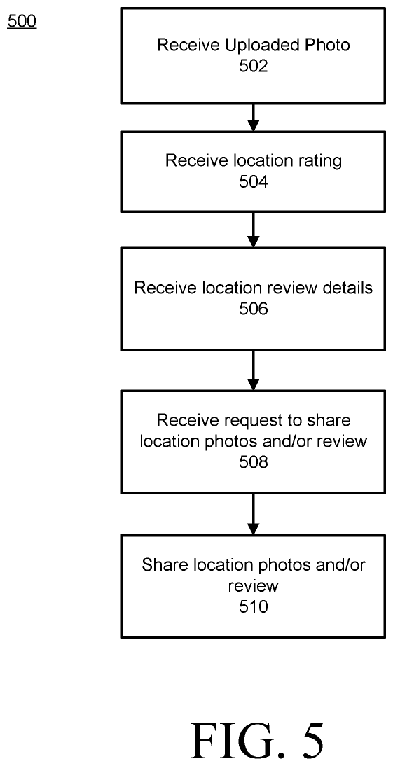

FIG. 5 is a flowchart of an example method 500 for uploading user generated content via a photo location destination mobile application in accordance with some implementations. Processing begins at 502, where a photo associated with a photo location destination is received from a user upload. Processing continues to 504.

At 504, a rating of the photo location destination associated with the uploaded phot is received. The rating can include one or more of a star rating, text review, or other rating information. Processing continues to 506.

At 506, additional rating or review details are optionally received such as a detailed review, ratings of specific features of the photo location destination, or other rating or review information. Processing continues to 508.

At 508, a request to share one or more photos and/or rating/review of a photo location destination is received. Processing continues to 510.

At 510, the photos and/or rating/review is shared with one or more other users based on the request.

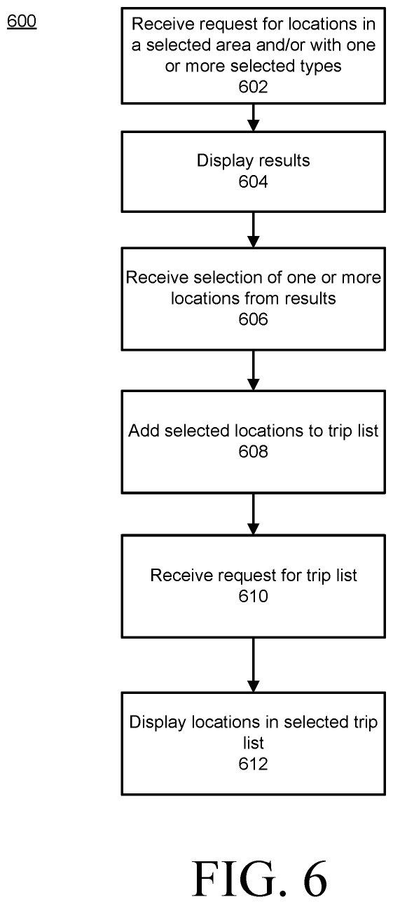

FIG. 6 is a flowchart of an example method 600 for building a trip itinerary via a photo location destination mobile application in accordance with some implementations. Processing begins at 602, where a request for locations in a selected area and/or with one or more selected types is received at a photo location destinations system from a user via a photo location destinations mobile application. Processing continues to 604.

At 604, results corresponding to the request are displayed. The results can include results of a database query (e.g., display photo location destinations near user location and matching selected type). In addition to the results of the database query or as a way to order results of the query, outputs of a machine learning model as discussed below can be used to provide suggestions to the user or to rank database query results. Processing continues to 606.

At 606, a selection of one or more of the photo location destination results is received from a user via a photo location destinations mobile application. Processing continues to 608.

At 608, the one or more selected photo location destinations are added to a trip (or itinerary). Processing continues to 610.

At 610, a request is received for the trip. Processing continues to 612.

At 612, locations in the requested trip are caused to be displayed on the photo location destinations mobile application along with directions and other associated information for the locations in the trip.

FIG. 7 is a block diagram of an example device 700 which may be used to implement one or more features described herein. In one example, device 700 may be used to implement a client device, e.g., any of client devices 120-126 shown in FIG. 1. Alternatively, device 700 can implement a server device, e.g., server device 104, etc. In some implementations, device 700 may be used to implement a client device, a server device, or a combination of the above. Device 700 can be any suitable computer system, server, or other electronic or hardware device as described above.

One or more methods described herein (e.g., those shown in FIGS. 4-6) can be run in a standalone program that can be executed on any type of computing device, a program run on a web browser, a mobile application (“app”) run on a mobile computing device (e.g., cell phone, smart phone, tablet computer, wearable device (wristwatch, armband, jewelry, headwear, virtual reality goggles or glasses, augmented reality goggles or glasses, head mounted display, etc.), laptop computer, etc.).

In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

In some implementations, device 700 includes a processor 702, a memory 704, and I/O interface 706. Processor 702 can be one or more processors and/or processing circuits to execute program code and control basic operations of the device 700. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems.

In some implementations, processor 702 may include one or more co-processors that implement neural-network processing. In some implementations, processor 702 may be a processor that processes data to produce probabilistic output, e.g., the output produced by processor 702 may be imprecise or may be accurate within a range from an expected output. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 704 is typically provided in device 700 for access by the processor 702, and may be any suitable processor-readable storage medium, such as random access memory (RAM), read-only memory (ROM), Electrically Erasable Read-only Memory (EEPROM), Flash memory, etc., suitable for storing instructions for execution by the processor, and located separate from processor 702 and/or integrated therewith. Memory 704 can store software operating on the server device 700 by the processor 702, including an operating system 708, machine-learning application 730, photo location destinations application 712, and application data 714. Other applications may include applications such as a data display engine, web hosting engine, image display engine, notification engine, social networking engine, etc. In some implementations, the machine-learning application 730 and photo location destinations application 712 can each include instructions that enable processor 702 to perform functions described herein, e.g., some or all of the methods of FIGS. 4-6.

The machine-learning application 730 can include one or more NER implementations for which supervised and/or unsupervised learning can be used. The machine learning models can include multi-task learning based models, residual task bidirectional LSTM (long short-term memory) with conditional random fields, statistical NER, etc. The Device 700 can also include a photo location destinations application 712 as described herein and other applications. One or more methods disclosed herein can operate in several environments and platforms, e.g., as a stand-alone computer program that can run on any type of computing device, as a web application having web pages, as a mobile application (“app”) run on a mobile computing device, etc.

In various implementations, machine-learning application 730 may utilize Bayesian classifiers, support vector machines, neural networks, or other learning techniques. In some implementations, machine-learning application 730 may include a trained model 734, an inference engine 736, and data 732. In some implementations, data 432 may include training data, e.g., data used to generate trained model 734. For example, training data may include any type of data suitable for training a model for photo location destinations tasks, such as images, labels, thresholds, etc. associated with photo location destinations described herein. Training data may be obtained from any source, e.g., a data repository specifically marked for training, data for which permission is provided for use as training data for machine-learning, etc. In implementations where one or more users permit use of their respective user data to train a machine-learning model, e.g., trained model 734, training data may include such user data. In implementations where users permit use of their respective user data, data 732 may include permitted data.

In some implementations, data 732 may include collected data such as user generated content associated with photo location destinations. In some implementations, training data may include synthetic data generated for the purpose of training, such as data that is not based on user input or activity in the context that is being trained, e.g., data generated from simulated conversations, computer-generated images, etc. In some implementations, machine-learning application 730 excludes data 732. For example, in these implementations, the trained model 734 may be generated, e.g., on a different device, and be provided as part of machine-learning application 730. In various implementations, the trained model 734 may be provided as a data file that includes a model structure or form, and associated weights. Inference engine 736 may read the data file for trained model 734 and implement a neural network with node connectivity, layers, and weights based on the model structure or form specified in trained model 734.

Machine-learning application 730 also includes a trained model 734. In some implementations, the trained model 734 may include one or more model forms or structures. For example, model forms or structures can include any type of neural-network, such as a linear network, a deep neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that takes as input sequential data, such as words in a sentence, frames in a video, etc. and produces as output a result sequence), etc.

The model form or structure may specify connectivity between various nodes and organization of nodes into layers. For example, nodes of a first layer (e.g., input layer) may receive data as input data 732 or application data 714. Such data can include, for example, images, e.g., when the trained model is used for photo location destinations functions. Subsequent intermediate layers may receive as input output of nodes of a previous layer per the connectivity specified in the model form or structure. These layers may also be referred to as hidden layers. A final layer (e.g., output layer) produces an output of the machine-learning application. For example, the output may be a set of labels for an image, an indication that an image includes a photo location destination, etc. depending on the specific trained model. In some implementations, model form or structure also specifies a number and/or type of nodes in each layer.

In different implementations, the trained model 734 can include a plurality of nodes, arranged into layers per the model structure or form. In some implementations, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output.

In some implementations, the computation performed by a node may also include applying a step/activation function to the adjusted weighted sum. In some implementations, the step/activation function may be a nonlinear function. In various implementations, such computation may include operations such as matrix multiplication. In some implementations, computations by the plurality of nodes may be performed in parallel, e.g., using multiple processors cores of a multicore processor, using individual processing units of a GPU, or special-purpose neural circuitry. In some implementations, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM). Models with such nodes may be useful in processing sequential data, e.g., words in a sentence or a paragraph, frames in a video, speech or other audio, etc.

In some implementations, trained model 734 may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using data 732, to produce a result.

For example, training may include applying supervised learning techniques. In supervised learning, the training data can include a plurality of inputs (e.g., a set of images) and a corresponding expected output for each input (e.g., one or more labels for each image representing aspects of a photo location destination corresponding to the images such as directions or reviews). Based on a comparison of the output of the model with the expected output, values of the weights are automatically adjusted, e.g., in a manner that increases a probability that the model produces the expected output when provided similar input.

In some implementations, training may include applying unsupervised learning techniques. In unsupervised learning, only input data may be provided and the model may be trained to differentiate data, e.g., to cluster input data into a plurality of groups, where each group includes input data that are similar in some manner. For example, the model may be trained to identify photo location destinations that are associated with images and/or select thresholds for photo location destinations recommendations.

In another example, a model trained using unsupervised learning may cluster words based on the use of the words in data sources. In some implementations, unsupervised learning may be used to produce knowledge representations, e.g., that may be used by machine-learning application 730. In various implementations, a trained model includes a set of weights, or embeddings, corresponding to the model structure. In implementations where data 732 is omitted, machine-learning application 730 may include trained model 734 that is based on prior training, e.g., by a developer of the machine-learning application 730, by a third-party, etc. In some implementations, trained model 734 may include a set of weights that are fixed, e.g., downloaded from a server that provides the weights.

Machine-learning application 730 also includes an inference engine 736. Inference engine 736 is configured to apply the trained model 734 to data, such as application data 714, to provide an inference. In some implementations, inference engine 736 may include software code to be executed by processor 702. In some implementations, inference engine 736 may specify circuit configuration (e.g., for a programmable processor, for a field programmable gate array (FPGA), etc.) enabling processor 702 to apply the trained model. In some implementations, inference engine 736 may include software instructions, hardware instructions, or a combination. In some implementations, inference engine 736 may offer an application programming interface (API) that can be used by operating system 708 and/or photo location destinations application 712 to invoke inference engine 736, e.g., to apply trained model 734 to application data 714 to generate an inference.

Machine-learning application 730 may provide several technical advantages. For example, when trained model 734 is generated based on unsupervised learning, trained model 734 can be applied by inference engine 736 to produce knowledge representations (e.g., numeric representations) from input data, e.g., application data 714. For example, a model trained for photo location destinations tasks may produce predictions and confidences for given input information about photo location destinations. A model trained for suggesting photo location destinations may produce a suggestion for one or more photo location destinations. In some implementations, such representations may be helpful to reduce processing cost (e.g., computational cost, memory usage, etc.) to generate an output (e.g., a suggestion, a prediction, a classification, etc.). In some implementations, such representations may be provided as input to a different machine-learning application that produces output from the output of inference engine 736.

In some implementations, knowledge representations generated by machine-learning application 730 may be provided to a different device that conducts further processing, e.g., over a network. In such implementations, providing the knowledge representations rather than the images may provide a technical benefit, e.g., enable faster data transmission with reduced cost. In another example, a model trained for photo location destinations may produce a photo location destinations image signal for one or more images being processed by the model.

In some implementations, machine-learning application 730 may be implemented in an offline manner. In these implementations, trained model 734 may be generated in a first stage and provided as part of machine-learning application 730. In some implementations, machine-learning application 730 may be implemented in an online manner. For example, in such implementations, an application that invokes machine-learning application 730 (e.g., operating system 708, one or more of photo location destinations 712 or other applications) may utilize an inference produced by machine-learning application 730, e.g., provide the inference to a user, and may generate system logs (e.g., if permitted by the user, an action taken by the user based on the inference; or if utilized as input for further processing, a result of the further processing). System logs may be produced periodically, e.g., hourly, monthly, quarterly, etc. and may be used, with user permission, to update trained model 734, e.g., to update embeddings for trained model 734.

In some implementations, machine-learning application 730 may be implemented in a manner that can adapt to particular configuration of device 700 on which the machine-learning application 730 is executed. For example, machine-learning application 730 may determine a computational graph that utilizes available computational resources, e.g., processor 702. For example, if machine-learning application 730 is implemented as a distributed application on multiple devices, machine-learning application 730 may determine computations to be carried out on individual devices in a manner that optimizes computation. In another example, machine-learning application 730 may determine that processor 702 includes a GPU with a particular number of GPU cores (e.g., 1000) and implement the inference engine accordingly (e.g., as 1000 individual processes or threads).

In some implementations, machine-learning application 730 may implement an ensemble of trained models. For example, trained model 734 may include a plurality of trained models that are each applicable to same input data. In these implementations, machine-learning application 730 may choose a particular trained model, e.g., based on available computational resources, success rate with prior inferences, etc. In some implementations, machine-learning application 730 may execute inference engine 736 such that a plurality of trained models is applied. In these implementations, machine-learning application 730 may combine outputs from applying individual models, e.g., using a voting-technique that scores individual outputs from applying each trained model, or by choosing one or more particular outputs. Further, in these implementations, machine-learning application may apply a time threshold for applying individual trained models (e.g., 0.5 ms) and utilize only those individual outputs that are available within the time threshold. Outputs that are not received within the time threshold may not be utilized, e.g., discarded. For example, such approaches may be suitable when there is a time limit specified while invoking the machine-learning application, e.g., by operating system 708 or one or more other applications, e.g., photo location destinations application 712.

In different implementations, machine-learning application 730 can produce different types of outputs. For example, machine-learning application 730 can provide representations or clusters (e.g., numeric representations of input data), labels (e.g., for input data that includes images, documents, etc.), phrases or sentences (e.g., descriptive of an image or video, suitable for use as a response to an input sentence, suitable for use to determine context during a conversation, etc.), images (e.g., generated by the machine-learning application in response to input), audio or video (e.g., in response an input video, machine-learning application 730 may produce an output video with a particular effect applied, e.g., rendered in a comic-book or particular artist's style, when trained model 734 is trained using training data from the comic book or particular artist, etc. In some implementations, machine-learning application 730 may produce an output based on a format specified by an invoking application, e.g., operating system 708 or one or more applications, e.g., photo location destinations application 712. In some implementations, an invoking application may be another machine-learning application. For example, such configurations may be used in generative adversarial networks, where an invoking machine-learning application is trained using output from machine-learning application 730 and vice-versa.

Any of software in memory 704 can alternatively be stored on any other suitable storage location or computer-readable medium. In addition, memory 704 (and/or other connected storage device(s)) can store one or more messages, one or more taxonomies, electronic encyclopedia, dictionaries, thesauruses, knowledge bases, message data, grammars, user preferences, and/or other instructions and data used in the features described herein. Memory 704 and any other type of storage (magnetic disk, optical disk, magnetic tape, or other tangible media) can be considered “storage” or “storage devices.”

I/O interface 706 can provide functions to enable interfacing the server device 700 with other systems and devices. Interfaced devices can be included as part of the device 700 or can be separate and communicate with the device 700. For example, network communication devices, storage devices (e.g., memory and/or database 106), and input/output devices can communicate via I/O interface 706. In some implementations, the I/O interface can connect to interface devices such as input devices (keyboard, pointing device, touchscreen, microphone, camera, scanner, sensors, etc.) and/or output devices (display devices, speaker devices, printers, motors, etc.).

Some examples of interfaced devices that can connect to I/O interface 706 can include one or more display devices 720 and one or more data stores 738 (as discussed above). The display devices 720 that can be used to display content, e.g., a user interface of an output application as described herein. Display device 720 can be connected to device 700 via local connections (e.g., display bus) and/or via networked connections and can be any suitable display device. Display device 720 can include any suitable display device such as an LCD, LED, or plasma display screen, CRT, television, monitor, touchscreen, 3-D display screen, or other visual display device. For example, display device 720 can be a flat display screen provided on a mobile device, multiple display screens provided in a goggles or headset device, or a monitor screen for a computer device.

The I/O interface 706 can interface to other input and output devices. Some examples include one or more cameras which can capture images. Some implementations can provide a microphone for capturing sound (e.g., as a part of captured images, voice commands, etc.), audio speaker devices for outputting sound, or other input and output devices.

For ease of illustration, FIG. 7 shows one block for each of processor 702, memory 704, I/O interface 706, and software blocks 708, 712, and 730. These blocks may represent one or more processors or processing circuitries, operating systems, memories, I/O interfaces, applications, and/or software modules. In other implementations, device 700 may not have all of the components shown and/or may have other elements including other types of elements instead of, or in addition to, those shown herein. While some components are described as performing blocks and operations as described in some implementations herein, any suitable component or combination of components of environment 100, device 700, similar systems, or any suitable processor or processors associated with such a system, may perform the blocks and operations described.

In some implementations, logistic regression can be used for personalization (e.g., personalizing photo location destinations suggestions based on a user's pattern of photo location destinations activity). In some implementations, the prediction model can be handcrafted including hand selected photo location destinations labels and thresholds. The mapping (or calibration) from ICA space to a predicted precision within the photo location destinations space can be performed using a piecewise linear model.

In some implementations, the photo location destinations system could include a machine-learning model (as described herein) for tuning the system (e.g., selecting photo location destinations labels and corresponding thresholds) to potentially provide improved accuracy. Inputs to the machine learning model can include ICA labels, an image descriptor vector that describes appearance and includes semantic information about photo location destinations. Example machine-learning model input can include labels for a simple implementation and can be augmented with descriptor vector features for a more advanced implementation. Output of the machine-learning module can include a prediction of photo location destinations.

One or more methods described herein (e.g., methods shown in FIGS. 4-6) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

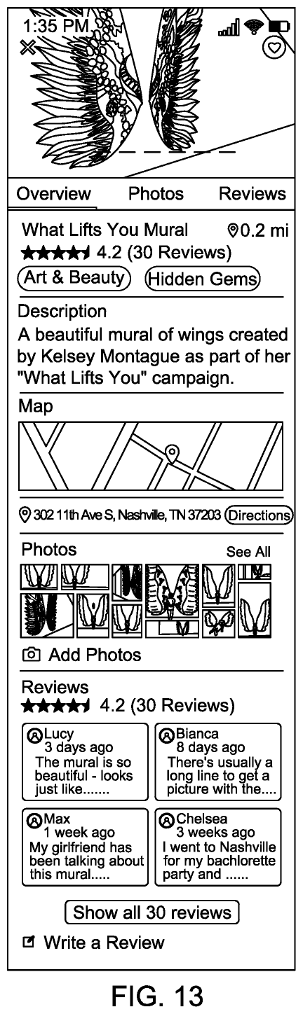

FIG. 13 shows an example user interface screen for a photo location destination. The photo location destination user interface can include an overview tab, a photos (or video or other media) tab, and/or a reviews tab. The photo location destination user interface can also include a description of the photo destination location, a map showing the location of the photo location destination, a directions element, a photos (or videos or other media) section showing media or content created by users at the photo location destination, a reviews section, a show all reviews element, and a write a review element.

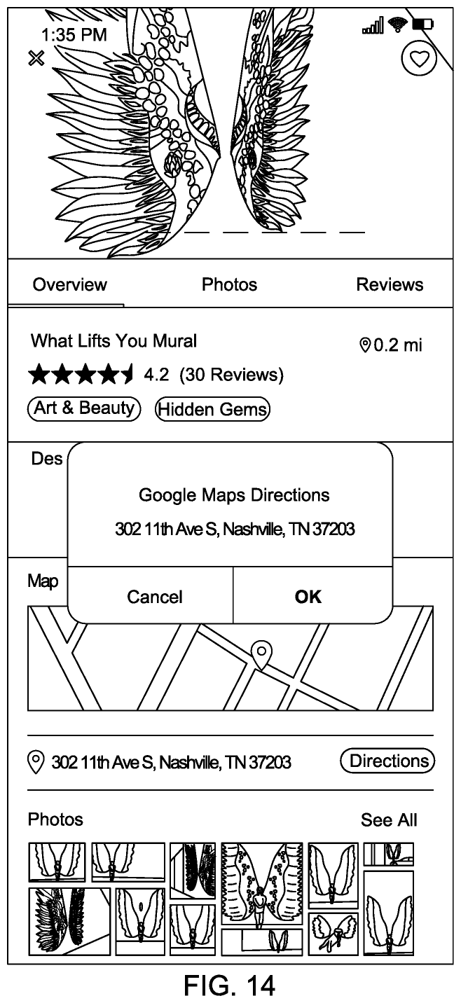

As shown in FIG. 14, a mapping service such as Google Maps or the like can be used to obtain directions to the photo location destination.

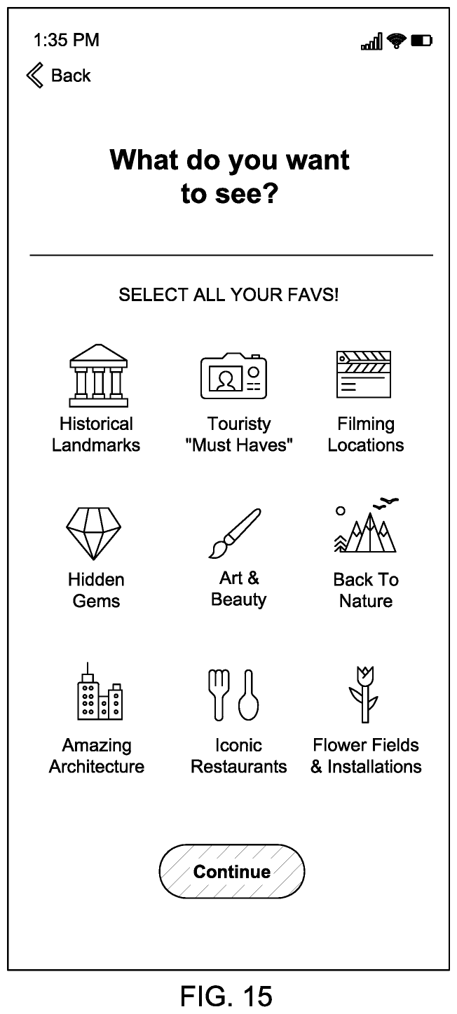

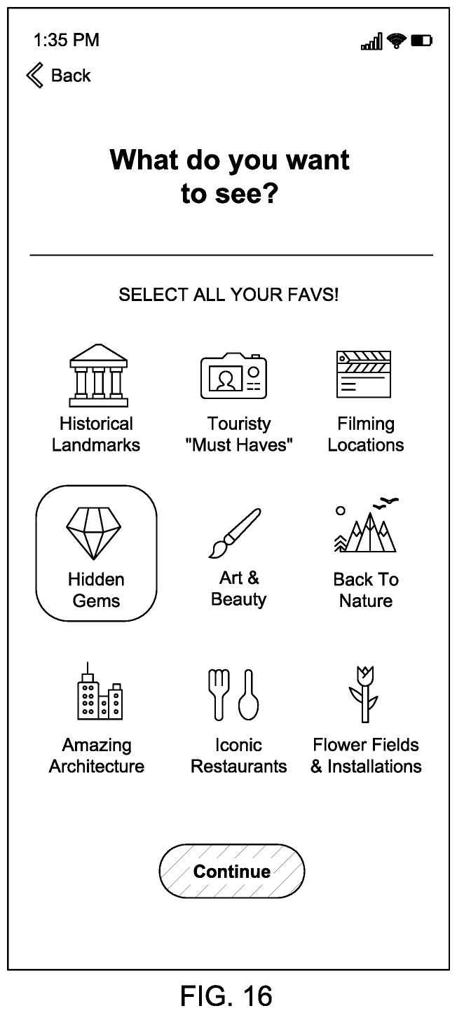

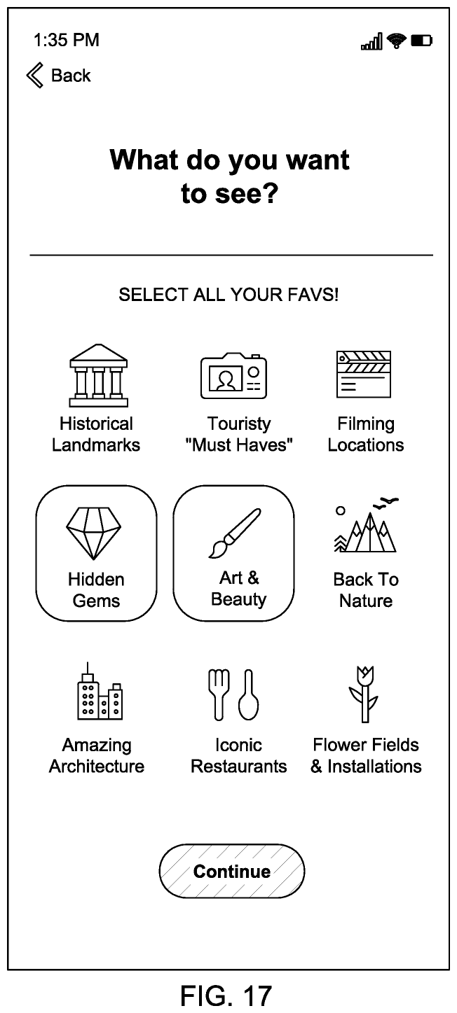

As shown in FIG. 15, photo destination locations can be categorized by type and those types can be used by the mobile application to recommend certain photo location destinations based on types that a given user is interested in. As shown in FIG. 16, Hidden Gems has been selected. As shown in FIG. 17, Art & Beauty has been selected in addition to Hidden Gems.

What is claimed is:

1. A method comprising:
authenticating a user via log in credentials;
receiving a search query or a selection of device location;
receiving a type of location;
searching a database of locations using one or more of the search query, the device location, or the type of location to obtain one or more search results; and
displaying the one or more search results.

2. The method of claim 1, further comprising:
receiving one or more uploaded photos, videos, or other media;
receiving a location rating;
receiving location review details;
receiving a request to share location photos or review; and
sharing location photos or review.
